(19) United States
(12) Patent Application Publication
(10) Pub. No.: US 2006/0158149 A1
(43) Pub. Date: Jul. 20, 2006

(54) PORTABLE RECHARGEABLE POWER UNIT

(76) Inventor: Monte B. Shilts, Stanley, WI (US)

Correspondence Address: DONALD R. SCHOONOVER, 4211 ROLLING HILLS DRIVE, NIXA, MO, 65714-8771, US

(21) Appl. No.: 10/905,642

(22) Filed: Jan. 14, 2005

(51) Int. Cl. H02J 7/35

(52) U.S. Cl. 320/101

(57) ABSTRACT

A unit includes a rechargeable power source, such as rechargeable battery or the like, and a solar powered power source recharging element. The unit can be coupled to a powered device, such as a hand held tool or the like, to provide power for that device.

### BACKGROUND OF THE INVENTION

The present invention relates to the general art of electricity, and to the particular field of battery charging using solar energy.

Nearly every electronic device requires a power source. In some cases, this power source can be utility power; however, in many other cases, the device must carry its own source of power. This is especially so if the device is intended to be portable, such as a PDA or the like. The device may become useless if the power source becomes depleted, and will be useless if the power source is exhausted.

Therefore, there is a need for a power source for a portable device which will not become depleted or exhausted.

While many power sources include rechargeable batteries, these batteries must be separately charged. That is, the user must remember to place the batteries in a charging mode or on a charger. If the batteries are not recharged, they will suffer the same problems as any other battery. If special actions are required to recharge the power source, such as removing a battery and placing that battery in a charger, or changing an operating mode of a device from “use mode” to “recharge mode,” a user may forget to recharge the power source and the power source may be depleted or exhausted.

Therefore, there is a need for a power source for a portable device which will not become depleted or exhausted but which does not require special actions to recharge the power source.

While the inventor is aware of some rechargeable power sources, such as cellular telephone power sources, and the like; however, these devices do not include both a recharging element and a power element that are a unit.

Therefore, there is a need for a unit that is portable and which includes both a rechargeable power element and an element that will continuously recharge that power element whereby the portable device will not become depleted or exhausted and which does not require special actions to recharge the power source.

### PRINCIPAL OBJECTS OF THE INVENTION

It is a main object of the present invention to provide a power source for a portable device which will not become depleted or exhausted.

It is another object of the present invention to provide a portable device which will not become depleted or exhausted but which does not require special actions to recharge the power source.

It is another object of the present invention to provide a unit that is portable and which includes both a rechargeable power element and an element that will continuously recharge that power element whereby the portable device will not become depleted or exhausted and which does not require special actions to recharge the power source.

### SUMMARY OF THE INVENTION

These, and other, objects are achieved by a portable unit that includes both a rechargeable power supply and a solar powered unit that recharges the power supply using solar power.

Using the portable rechargeable power unit embodying the present invention will permit a device to be powered on a continuous basis and does not require a user to take any special steps to recharge the unit.

### BRIEF DESCRIPTION OF THE DRAWING FIGURES

FIG. 1 is a perspective view of a portable rechargeable power unit embodying the present invention.

FIG. 2 shows a hand held device which includes the portable rechargeable power unit shown in FIG. 1.

FIG. 3 is another form of the portable rechargeable power unit embodying the present invention.

FIG. 4 is an exploded, partially perspective, view of a powered device which includes the portable rechargeable power unit embodying the present invention.

### DETAILED DESCRIPTION OF THE PREFERRED EMBODIMENT

Other objects, features and advantages of the invention will become apparent from a consideration of the following detailed description and the accompanying drawings.

Referring to the Figures, it can be understood that the present invention is embodied in a portable rechargeable power unit 10 which comprises a rechargeable battery 12 which is of the usual type of rechargeable battery well known to those skilled in the art. Unit 10 further includes an electrical connector 14 electrically connected to rechargeable battery 12. Electrical connector 14 is adapted to electrically connect battery 12 to a device that requires electrical power. One such device is shown in FIG. 2 as being a hand-held drill 20. However, other devices, such as a cellular telephone, a PDA, or the like, can be used without departing from the scope of the present disclosure and no limitation is intended by the showing of a hand-held drill.

Unit 10 further includes a solar powered battery recharging element 30 which is electrically connected to rechargeable battery 12 by a connector 32.

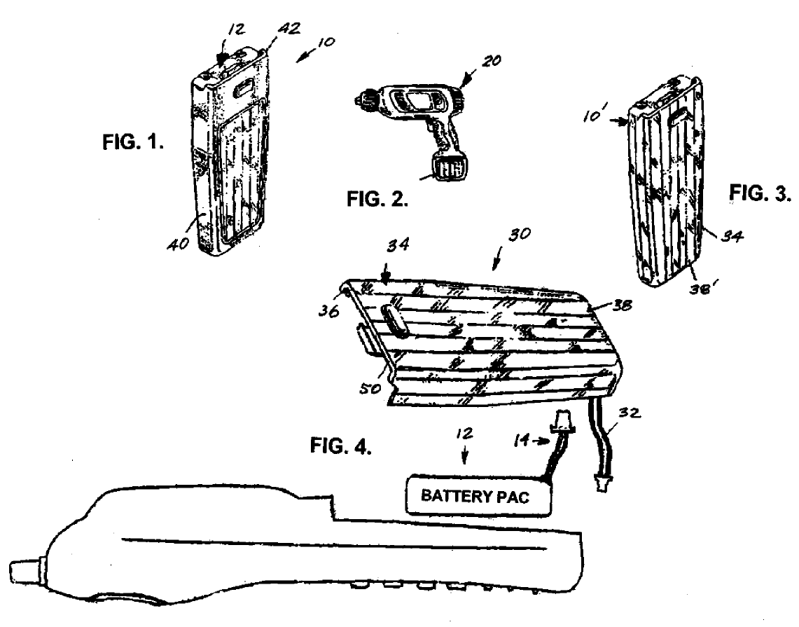

Element 30 can include a case 34 into which battery 12 is slidably accommodated. Case 34 includes a first surface 36 which is an outside surface when the case 34 is in use and on which a solar panel 38 is located. Case 34 further includes two side walls, 40 and 42, which are channel shaped and which are sized to slidably receive battery 12. Connector 32 is accommodated in case 34. Case 34 has solar panel 38 on first surface 36. In FIG. 1, solar panel 38 covers only a portion of first surface 36 and in FIG. 3, solar panel 38′ covers essentially the entire first surface 36′.

In one form of unit 10, case 34 includes a second surface 50 against which battery 12 abuts when the battery 12 is accommodated in the case 34 and electrical connector 32 is located adjacent to second surface 50 to be located inside case 34.

Use of unit 10 will be understood from the teaching of the foregoing disclosure and thus will not be discussed in detail. Unit 10 is used by placing battery 12 in case 34, and connecting connector 32 to the solar panel 38. Connector 14 is then connected to the device to be powered. Battery 12 will be recharged by the solar panel 38 whenever the solar panel 38 is exposed to light and thus battery 12 will always be charged.

It is understood that while certain forms of the present invention have been illustrated and described herein, it is not to be limited to the specific forms or arrangements of parts described and shown.

What is claimed is:

1. A portable rechargeable power unit comprising:
(a) a rechargeable battery;
(b) an electrical connector electrically connected to said rechargeable battery, said electrical connector being adapted to electrically connect said battery to a device that requires electrical power; and
(c) a solar powered battery recharging element electrically connected to said rechargeable battery, said solar powered battery recharging element including
(1) a case which includes a first surface that is an outer surface when said solar powered battery recharging element is in use, a first side element, and a second side element,
(2) each of the side elements being channel shaped, with a channel being defined thereby, the channel defined by each of the side elements being sized to slidably accommodate said rechargeable battery, and
(3) a solar panel on the first surface of the case.

2. The portable rechargeable power unit as described in claim 1 wherein the device includes a hand-held tool.

3. The portable rechargeable power unit as described in claim 2 wherein the hand-held tool includes a drill.

4. The portable rechargeable power unit as described in claim 1 wherein the first surface is essentially entirely covered by the solar panel.

5. The portable rechargeable power unit as described in claim 1 wherein the case further includes a second surface against which said rechargeable battery abuts when said rechargeable battery is accommodated in said case and said electrical connector is located adjacent to the second surface.
